(19) United States
(12) Patent Application Publication
(10) Pub. No.: US 2005/0286104 A1
(43) Pub. Date: Dec. 29, 2005

(54) Optical scanner

(75) Inventors: Makiko Sugiura, Hekinan-city (JP); Inao Toyoda, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/153,384

(22) Filed: Jun. 16, 2005

(30) Foreign Application Priority Data
Jun. 24, 2004 (JP) 2004-185837

(51) Int. Cl. G02B 26/08

(52) U.S. Cl. 359/210; 359/196

(57) ABSTRACT

An optical scanner is provided with a laser diode for emitting a laser beam, a cylinder lens arranged in a laser route of the laser beam, and a static electricity force driving device (or electromagnetic force driving device) for moving the cylinder lens in a direction perpendicular to the laser route. Thus, the incidence position of the laser beam with respect to the cylinder lens is changeable. Accordingly, the laser beam having entered the cylinder lens is refracted at different refraction angles to be dispersed, thus being capable of scanning an object.

### CROSS REFERENCE TO RELATED APPLICATION

This application is based on Japanese Patent Application No. 2004-185837 filed on Jun. 24, 2004, the disclosure of which is incorporated herein by reference.

### FIELD OF THE INVENTION

The present invention relates to an optical scanner for scanning an object by a light beam.

### BACKGROUND OF THE INVENTION

Generally, an optical scanner is provided to scan an object by laser light emitted by a luminescence element, for example, referring to JP-2002-31685A. The laser light from the luminous element is reflected by a revolving polygon mirror to outgo from the optical scanner through an outgoing window of the optical scanner. Thus, the optical scanner can scan the object in a predetermined angle range.

However, in this case, the polygon mirror is provided with a series of plane reflection surfaces around it, and revolved to control the direction of the laser light. The polygon mirror occupies a relatively large space in the optical scanner. Furthermore, a driving motor with a high capacity is necessary to rotate the polygon mirror, which is big and heavy.

Therefore, it is difficult to small-size and weight-reduce the optical scanner having the polygon mirror and the driving motor. Moreover, the power cost of the optical scanner (driving motor) is high.

Thus, the mounting position of the optical scanner is limited. For example, when the optical scanner is used in a vehicle distance detection system for detecting the distance between vehicles, it is difficult to mount the optical scanner at a position (higher than a road surface) with a good visibility, for example, the backside of a back mirror in a passenger compartment. The optical scanner is to be mounted at a relatively large space, for example, the inner side of a front grill or the left-right direction center portion of a front bumper of the vehicle.

Instead of the polygon mirror for controlling the outgoing direction of the laser light, the optical scanner can be provided with a flat-shaped mirror for reflecting the laser light with an adjustable reflection angle, or multiple light guide routes, the directions of which are adjustable. However, it is difficult to small-size and weight-reduce the above-described optical scanners.

### SUMMARY OF THE INVENTION

In view of the above-described disadvantages, it is an object of the present invention to provide an optical scanner which is small-sized and weight-reduced.

According to the present invention, an optical scanner includes a light source for emitting a light beam, a dispersion lens arranged in a light route of the light beam, and a driving unit, which moves at least one of the light source and the dispersion lens in at least a direction perpendicular to the light route so that an incidence position of the light beam with respect to the dispersion lens is changeable.

Because at least one of the light source and the dispersion lens is movable in the direction perpendicular to the light route, the laser beam can be refracted at different refraction angles to be capable of scanning an object. Therefore, the optical scanner can be small-sized at least in the direction of the laser route, as compared with that having a revolving polygon mirror. Accordingly, a driving motor for rotating the polygon mirror, which is large and heavy, is unnecessary, so that the size and weight of the optical scanner is further reduced. Therefore, the optical scanner can be mounted with less restriction.

Preferably, the dispersion lens is a columnar plano-concave lens having an incidence lens surface at an incidence side of the light beam and an outgoing lens surface at an outgoing side of the light beam. The incidence lens surface and the outgoing lens surface are respectively disposed at two opposite sides of the dispersion lens. The outgoing lens surface is curved in a longitudinal direction of the dispersion lens.

More preferably, the outgoing lens surface has a substantially zero curvature in a thickness direction of the dispersion lens. At least one of the light source and the dispersion lens is movable in the thickness direction of the dispersion lens.

Therefore, the laser beam can scan the object in both the longitudinal direction and the lateral direction of the columnar plano-concave lens. That is, the optical scanner which is small-sized and weight-reduced is capable of scanning the object at two dimensions.

### BRIEF DESCRIPTION OF THE DRAWINGS

Other objects, features and advantages of the present invention will become more apparent from the following detailed description made with reference to the accompanying drawings, in which:

FIG. 1 is a schematic perspective view showing a construction of a laser radar according to a first embodiment of the present invention;

FIG. 2A is a schematic perspective view showing a construction of an optical scanner according to the first embodiment, FIG. 2B is a schematic plan view of the optical scanner shown in FIG. 2A, and FIG. 2C is a schematic side view of the optical scanner shown in FIG. 2A;

FIG. 3A is a diagram for interpreting the law of refraction (Snell's law), FIG. 3B is a diagram for interpreting the principle of dispersion by a dispersion lens (cylinder lens), and FIG. 3C is a diagram for interpreting the principle of scanning by the dispersion lens (cylinder lens);

FIG. 4 is a schematic view showing a construction of a static electricity force driving device;

FIG. 5A is a schematic view showing a construction of an electromagnetic force driving device, and FIG. 5B is a schematic view showing a cross section of the electromagnetic force driving device along the line VB-VB in FIG. 5A;

FIG. 6A is a schematic perspective view showing a construction of an optical scanner according to a second embodiment of the present invention, FIG. 6B is a schematic plan view of the optical scanner shown in FIG. 6A, and FIG. 6C is a schematic side view of the optical scanner shown in FIG. 6A;

FIG. 7A is a schematic perspective view showing a construction of an optical scanner according to a third embodiment of the present invention, FIG. 7B is a schematic plan view of the optical scanner shown in FIG. 7A, and FIG. 7C is a schematic side view of the optical scanner shown in FIG. 7A;

FIG. 8A is a schematic perspective view showing a construction of an optical scanner according to a fourth embodiment of the present invention, FIG. 8B is a schematic plan view of the optical scanner shown in FIG. 8A, and FIG. 8C is a schematic side view of the optical scanner shown in FIG. 8A;

FIG. 9A is a schematic perspective view showing a construction of an optical scanner according to a fifth embodiment of the present invention, FIG. 9B is a schematic plan view of the optical scanner shown in FIG. 9A, and FIG. 9C is a schematic side view of the optical scanner shown in FIG. 9A;

FIG. 10A is a schematic perspective view showing a construction of an optical scanner according to a sixth embodiment of the present invention, FIG. 10B is a schematic plan view of the optical scanner shown in FIG. 10A, and FIG. 10C is a schematic side view of the optical scanner shown in FIG. 10A; and

FIG. 11A is a schematic perspective view showing a construction of an optical scanner according to a seventh embodiment of the present invention, FIG. 11B is a schematic plan view of the optical scanner shown in FIG. 11A, and FIG. 11C is a schematic side view of the optical scanner shown in FIG. 11A.

### DETAILED DESCRIPTION OF THE PREFERRED EMBODIMENTS

### First Embodiment

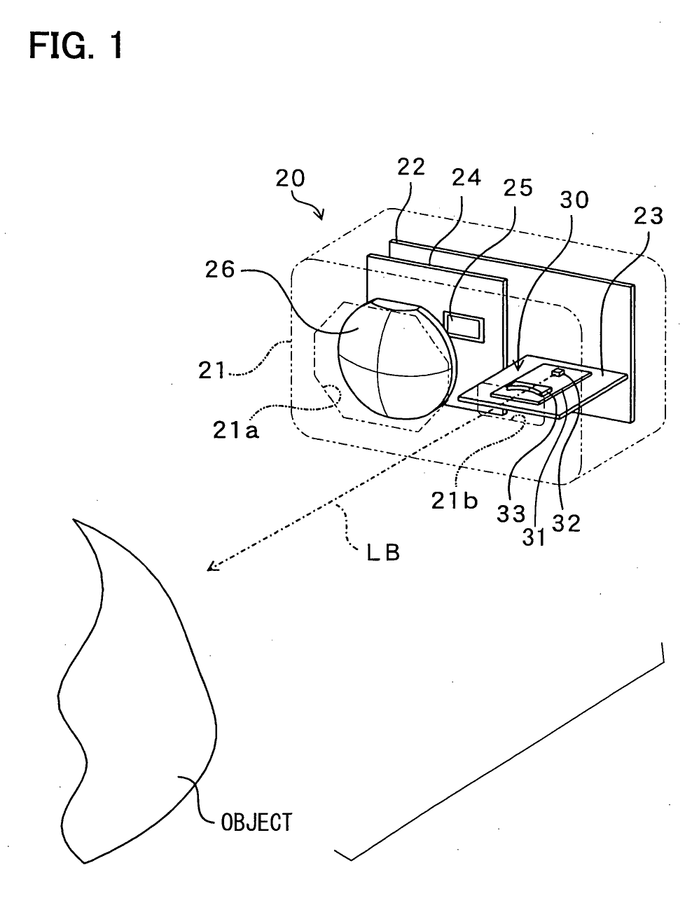

According to a first embodiment of the present invention with reference to FIGS. 1-5, an optical scanner 30 is suitably used in a laser radar 20. The laser radar 20 is mounted, for example, at the front portion of a passenger compartment (not shown) of a vehicle (own vehicle) to detect the position of other vehicle (e.g., front vehicle traveling at front side of own vehicle), or/and the distance between the front vehicle and the own vehicle. The laser radar 20 can be used in, for example, an auto cruise control system for bettering a driving comfort or a precrash system for improving a driving safety.

Referring to FIG. 1, the laser radar 20 includes a housing 21, a main board 22, a photoreception unit, an optical scanner 30 and the like. The photoreception unit has a sub-board 24, a photodiode 25 and a photoreception lens 26.

The box-shaped housing 21, being made of a resin or the like, accommodates the main board 22, the photoreception unit, the optical scanner 30 and the like. The housing 21 is provided with an outgoing window 21b, through which a light beam (e.g., laser beam LB) emitted by the optical scanner 30 can radiate to the outside of the housing 21, and an incoming window 21a, through which reflection light (e.g., reflection laser light) reflected by an object (e.g., front vehicle) can enter the photoreception lens 26 of the photoreception unit. In FIG. 1, the housing 21 is indicated by the two-point chain line, so that the main board 22, the photoreception unit and the optical scanner 30 which are accommodated therein can be clearly shown.

The main board 22 is mainly constructed of a microcomputer (not shown) which is, for example, an ASIC type including CPU, RAM, ROM, I/O interface and the like. The main board 22 generates data for controlling the optical scanner 30, or processes photoreception data sent by the photoreception unit. Furthermore, the main board 22 sends/receives data to/from an exterior vehicle electronic control unit (ECU). Specifically, the main board 22 receives data for setting detection modes from the ECU and sends alarm data about the object (e.g., front vehicle) to the ECU, for example. The main board 22 is electrically connected with a sub-board 23 of the optical scanner 30 or/and the sub-board 24 of the photoreception unit through a connector, a cable or the like (not shown). The main board 22 is communicated with the exterior ECU through a vehicle LAN under a communication protocol, for example, CAN (controller area network).

The photoreception unit is mainly constructed of the sub-board 24, the photodiode 25 mounted at the sub-board 24, the photoreception lens 26 and the like. The photoreception unit outputs the photoreception data indicating an existence of the object to the main board 22, when the photoreception unit receives the reflection laser light which is reflected by the object and enters the photoreception unit.

Specifically, when the refection laser light enters the photodiode 25 through the photoreception lens 26 (e.g., convergence lens such as Fresnel lens or the like) having a lens surface facing the incoming window 21a of the housing 21, the photodiode 25 receives the reflection laser light so that electric current (current) is caused in a signal process circuit of the sub-board 24. Then, the object can be detected according to the value of current. For example, the current in the signal process circuit of the sub-board 24 is converted into electric voltage (voltage). When the voltage exceeds a predetermined threshold value, it is determined that the object exists.

Then, a signal level of the photoreception data is switched from ‘LOW’ into ‘Hi’, for example. Thus, the incidence (photoreception) of the reflection laser light of the laser beam LB is determined. The laser beam LB is emitted by the optical scanner 30 at a predetermined angle. Thus, the microcomputer of the main board 22 can detect an existence of the object and the direction thereof. Moreover, the distance between the own vehicle and the object (e.g., front vehicle) can be calculated, by detecting the time from the emission of the laser beam LB (emitted by the optical scanner 30) to the incidence of the reflection laser light of the laser beam LB to the photoreception unit.

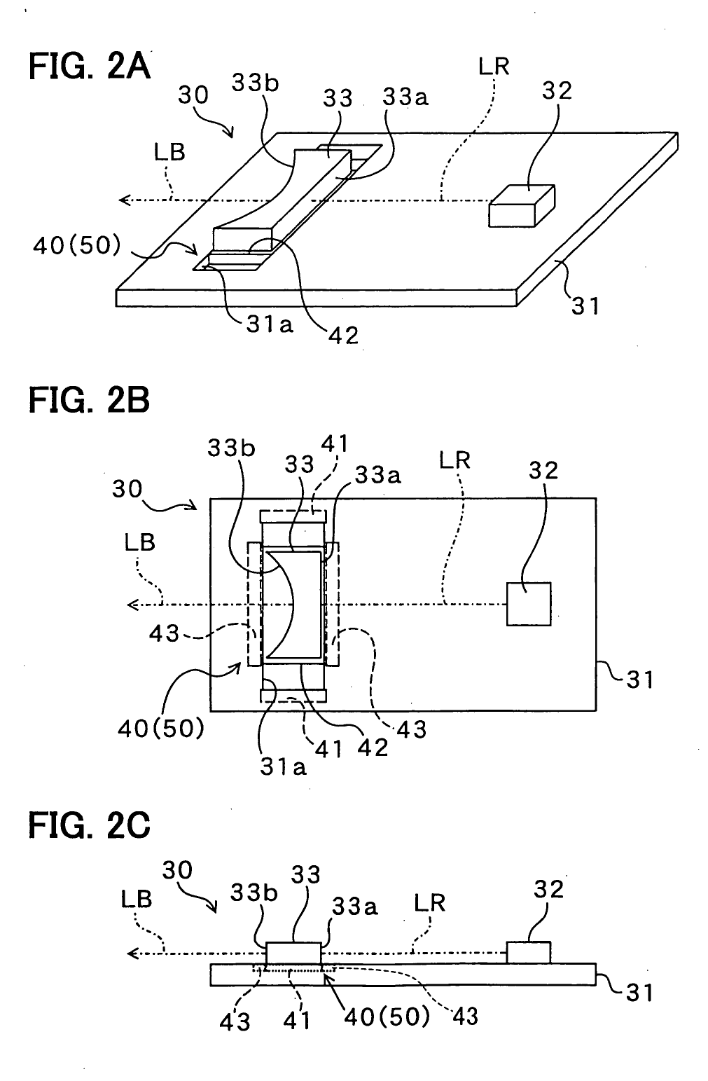

Referring to FIGS. 2A-2C, the optical scanner 30 includes a board 31, a laser diode 32 (light source), a cylinder lens 33, a static electricity force driving device 40 (driving unit) and the like. The optical scanner 30 is eclectically connected with the main board 22 through the sub-board 23.

At least a part of the board 31 is made of a semiconductor such as silicon and the like. The board 31 constructs the base of the optical scanner 30. The laser diode 32, the cylinder lens 33 and the static electricity force driving device 40 are mounted on the board 31. The board 31 is provided with a guide groove 31a. The cylinder lens 33, which is disposed at a slide table 42 of the static electricity force driving device 40, is slidable along the guide groove 31a in a direction perpendicular to a light route LR of the laser beam LB emitted by the laser diode 32, as described later. For example, the longitudinal direction (length direction) and the thickness direction of the cylinder lens 33 can be arranged to be perpendicular to the light route LR, and the cylinder lens 33 is slidable in the longitudinal direction thereof.

The laser diode 32 is a semiconductor laser luminescence element for emitting the light beam (laser beam LB) of, for example, a near infrared ray with a predetermined wavelength. Pulse current is supplied for the laser diode 32 by a driving circuit (not shown) formed at the sub-board 23, so that the laser diode 32 intermittently emits the laser beam LB. The width of the pulse can be set in a broad range, for example, from tens of nanoseconds to hundreds of milliseconds.

The cylinder lens 33, being made of quartz glass, plastic or the like, is a dispersion lens (e.g., negative lens or concave lense) dispersing parallel light. In this embodiment, the cylinder lens 33 is constructed of a columnar plano-concave lens having a lens surface 33a (incidence lens surface) at the incidence side of the laser beam LB and a lens surface 33b (outgoing lens surface) at the outgoing side of the laser beam LB. The incidence side lens surface 33a and the outgoing lens surface 33b are respectively disposed at two opposite sides of the cylinder lens 33.

The incidence lens surface 33a is plane. The outgoing lens surface 33b, being concave, is curved in a longitudinal direction (length direction) of the cylinder lens 33, but not curved in the thickness direction thereof. That is, the outgoing lens surface 33b has a substantially zero curvature in the thickness direction of the convergence lens.

Thus, the cylinder lens 33 is formed to have different curvatures at different parts thereof, so that the laser beam LB having entered the cylinder lens 33 can be refracted and dispersed by the cylinder lens 33.

The cylinder lens 33 driven by the static electricity force driving device 40 is movable in the longitudinal direction of the cylinder lens 33, that is, in the direction perpendicular to the light route LR of the laser beam LB emitted by the laser diode 32. The laser diode 32 is fixed at the board 31, so that the distance between the laser diode 32 and the cylinder lens 33 is maintained.

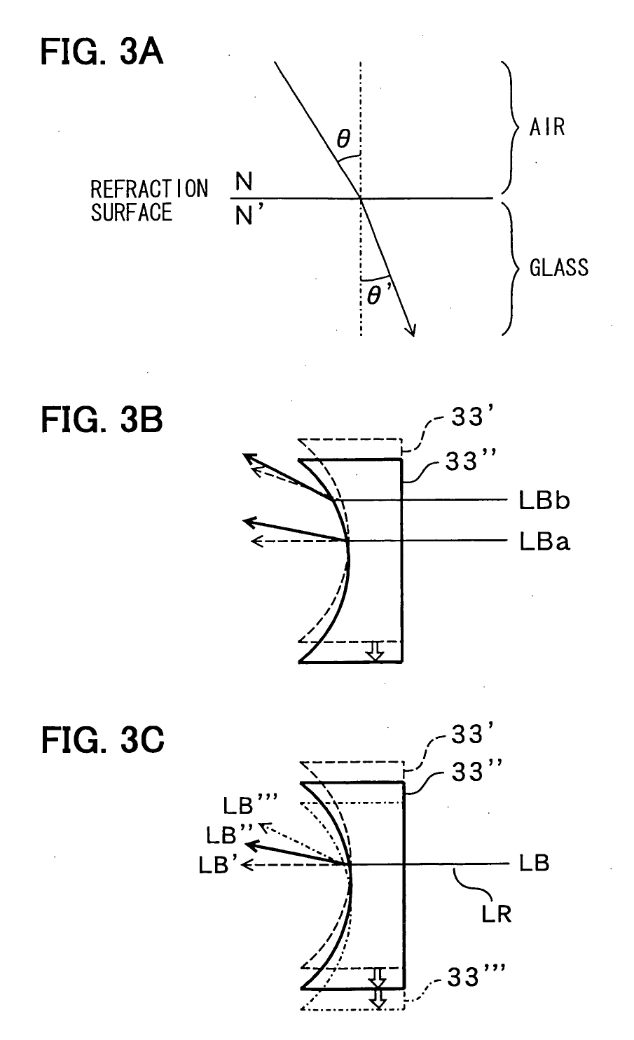

FIG. 3 shows a dispersion principle of the cylinder lens 33. According to the law of refraction (Snell's law) with reference to FIG. 3A, N×sin θ=N′×sin θ′, wherein N indicates a refractive index at one side of a refraction surface, N′ indicates a refractive index at other side of the refraction surface, θ indicates an angle (incidence angle) between an incidence light and a normal k of the refraction surface at an incidence point of the incidence light, and θ′ indicates an angle (refraction angle) between the normal k and a refraction light corresponding to the incidence light. In this embodiment, the one side of the refraction surface is air, and the other side thereof is the cylinder lens 33 (glass or the like).

As shown in FIG. 3B, when the cylinder lens 33 is moved from a broken-line position 33′ to the solid-line position 33″ in a direction (indicated by outline arrow in FIG. 3B) perpendicular to the light route LR of the laser Beam LB (indicated as ray LBa and ray LBb), the relative position of the cylinder lens 33 to the light route LR is changed so that the curvature of the cylinder lens 33 at a corresponding point is changed (for example, becomes larger). Thus, the refraction angle of the refraction light (indicated by solid line) of the laser beam LB at the solid-line position 33″ becomes larger, as compared with the refraction angle of the refraction light (indicated by broken line) of the laser beam LB at the broken-line position 33′. That is, the refraction light of the laser beam LB is dispersed at the solid-line position 33″, as compared with the broken-line position 33′.

On the contrary, when the cylinder 33 is moved from the solid-line position 33″ to the broken-line position 33′ in a direction contrary to that indicated by the outline arrow in FIG. 3B, the refraction angle of the refraction ray of the laser beam LB becomes smaller (from solid line position to broken line position).

Thus, the cylinder lens 33, being arranged in the light route LR of the laser beam LB, is reciprocated (vibrated) in the direction perpendicular to the laser route LR. The laser beam LB is emitted by the laser diode 32 which is fixed. Therefore, the laser beam LB having entered the cylinder lens 33 is refracted and dispersed at a fan shape, thus being capable of scanning the object.

Specifically, the laser diode 32 emits the laser beam LB at a predetermined interval due to a supply of the pulse current. As shown in FIG. 3C, when the cylinder lens 33 is disposed at the broken-line position 33′ at an initial time, the laser beam LB is refracted in a direction LB′ (indicated by broken line). When the cylinder lens 33 is disposed at the solid-line position 33″ at a following time, the laser beam LB is refracted in the direction LB′ (indicated by solid line). When the cylinder lens 33 is disposed at a one-point chain line position 33′″ at a further following time, the laser beam LB is refracted in a direction LB′″ (indicated by one-point chain line). Thus, the laser beam LB is refracted and dispersed by the cylinder lens 33, thus being capable of scanning the object.

The optical scanner 30 is provided with the static electricity force driving device 40 for moving the cylinder lens 33 in the direction perpendicular to the laser route LR of the laser beam LB, so that the relative position of the cylinder lens 33 to the laser route LR is changeable. The static electricity force driving device 40 is a static electricity actuator (micromachine), through which the cylinder lens 33 is driven by static electricity force as driving force.

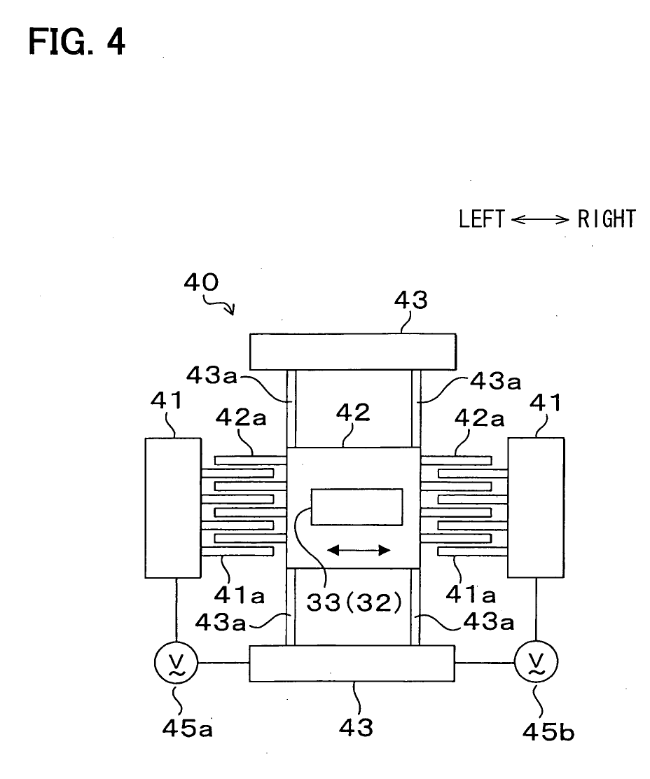

Referring to FIG. 4, the static electricity force driving device 40 includes a pair of first fixed electrodes 41, the slide table 42, a second fixed electrode 43, multiple (e.g., four) plate springs 43a and the like. These components of the static electricity force driving device 40 are formed on the board 31 through MEMS (Micro Electro Mechanical System).

The two first fixed electrodes 41 are arranged to face each other (for example, at left side and right side as indicated in FIG. 4), and apart from each other at a predetermined distance. Each of the first fixed electrodes 41 has a comb electrode 41a (having comb shape) at the side opposite to the other first fixed electrode 41.

The slide table 42, having a plate shape, is slidably arranged in the gap between the two first fixed electrodes 41. The slide table 42 is provided with two comb electrodes 42a (having comb shape), which are respectively arranged at two opposite sides (each of which faces one of first fixed electrodes 41) of the slide table 42. The tooth of the each comb electrode 41a is arranged between teeth of the comb electrode 42a which faces the comb electrode 41a. A gap is provided between the tooth of the comb electrode 41a and that of the comb electrode 42a.

The slide table 42 is connected with the plate springs 43a at two opposite sides where the comb electrodes 42a are not arranged. One end of each of the plate springs 43a is connected with the slide table 42, and the other end of the plate springs 43a is connected with the second fixed electrode 43. Thus, the second fixed electrode 43 is eclectically connected with the comb electrodes 42a of the slide table 42.

The slide table 42 is slidable along the guide groove 31a of the board 31 in the direction perpendicular to the laser route LR of the laser beam LB. The first fixed electrode 41 and the second fixed electrode 43 are fixed at the board 31. When the slide table 42 slides along a left-right direction indicated as the arrow direction in FIG. 4, the plate spring 43a connecting the second fixed electrode 43 and the slide table 42 exerts an elastic force to the slide table 42, so that the slide table 42 tends to return to the center position (balance position) which is indicated in FIG. 4.

When alternating voltages 45a and 45b are respectively supplied for the two first fixed electrodes 41, the slide table 42 will vibrate in the left-right direction (indicated as the arrow direction in FIG. 4), which corresponds to the direction perpendicular to the laser route LR of the laser beam LB. A phase difference of 90° is provided between the alternating voltages 45a and 45b. The frequency and voltage value of the alternating voltage 45a or 45b are adjustable.

Specifically, when the alternating voltage 45a is supplied between the first fixed electrode 41 of the left side and the second fixed electrode 43, the static electrical force is generated between the comb electrode 42a and the comb electrode 41a of the first fixed electrode 41 of the left side. Thus, the slide table 42 is periodically reciprocated between the center position indicated in FIG. 4 and a left side position thereof at a frequency which is double of that of the alternating voltage 45a.

Similarly, when the alternating voltage 45b is supplied between the first fixed electrode 41 of the right side and the second fixed electrode 43, the static electrical force is generated between the comb electrode 42a and the comb electrode 41a of the first fixed electrode 41 of the right side. Thus, the slide table 42 is periodically reciprocated between the center position indicated in FIG. 4 and a right side position thereof with a frequency which is double of that of the alternating voltage 45b.

Therefore, when the alternating voltages 45 and 45b are respectively supplied between the first fixed electrodes 41 (at left side and right side) and the second fixed electrode 43, the slide table 42 can be reciprocated in the left-right direction. Thus, the cylinder lens 33 which is mounted at the slide table 42 can slide in the direction perpendicular to the laser route LR of the laser beam LB. The slide speed of the slide table 42 can be controlled, by adjusting the frequency (switching frequency) of the alternating voltage 45a or 45b.

In the optical scanner 30 according to this embodiment, an electromagnetic force driving device 50 can be also used as the driving unit for moving the cylinder lens 33, instead of the static-electricity-force driving device 40.

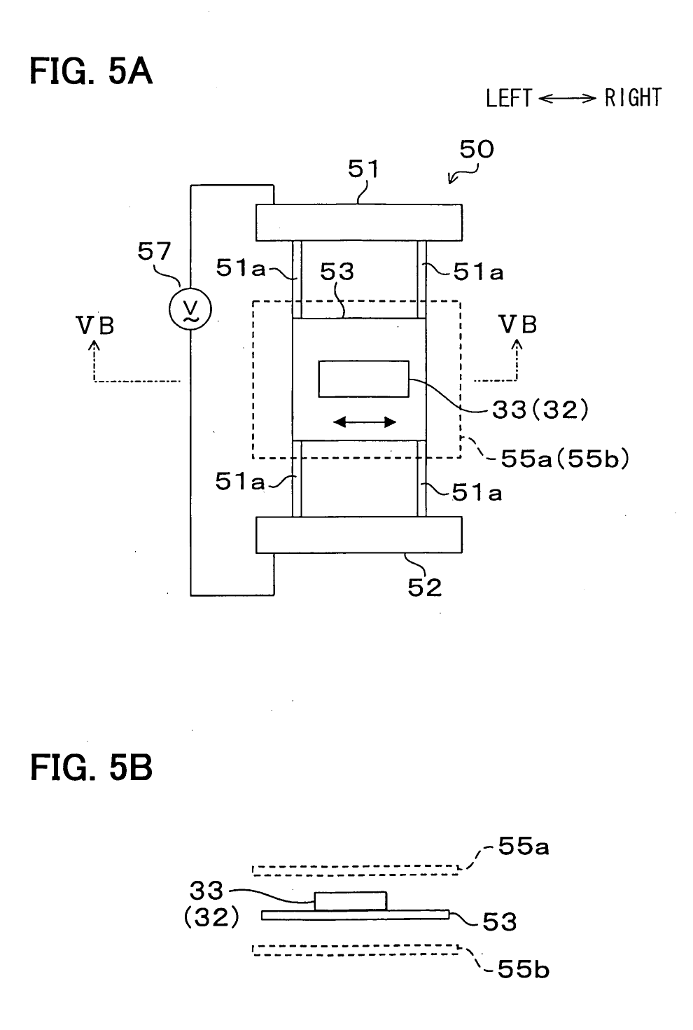

The electromagnetic force driving device 50 is a micromachine, through which the cylinder lens 33 is driven by electromagnetic force as driving force. As shown in FIGS. 5A and 5B, the electromagnetic force driving device 50 includes a first fixed electrode 51, a second fixed electrode 52, a slide table 53 having a plate shape, multiple (e.g., four) plate springs 51a, and magnets 55a, 55b. These components of the electromagnetic force driving device 50 are formed on the board 31 through MEMS. The magnets 55a and 55b are indicated by the broken line in FIGS. 5A and 5B.

The first fixed electrode 51 and the second fixed electrode 52 are respectively electrically connected with two opposite sides of the slide table 53 through the plate springs 51a. The left-right direction indicated by the arrow in FIG. 5 corresponds to the direction perpendicular to the laser route LR of the laser beam LB. That is, the slide table 53 is arranged between the first fixed electrode 51 and the second fixed electrode 52 with respect to the direction of the laser route LR. The slide table 53 is arranged between the two magnets 55a and 55b with respect to the thickness direction of the slide table 53 (cylinder lens 33), as shown in FIG. 5B. A gap is provided between the slide table 53 and the magnet 55a or 55b.

The slide table 53 is slidably arranged in the guide groove 31a in the left-right direction (i.e., direction perpendicular to laser route LR). When an alternating voltage 57 is supplied between the first fixed electrode 51 and the second foxed electrode 52, the slide table 53 vibrates in the left-right direction (i.e., arrow direction in FIG. 5). The frequency and voltage of the alternating voltage 57 are adjustable. When the slide table 53 deviates from the center position (balance position) indicated in FIG. 5A, the plate springs 51a exerts elastic force to the slide table 53 so that the slide table 53 tends to return to the center position.

Specifically, when current flows from the first fixed electrode 51 toward the second fixed electrode 52 due to the alternating voltage 57, magnetic flux in the direction from paper back toward paper face of FIG. 5A (that is, in direction from magnet 55b toward magnet 55a in FIG. 5B) is generated according to Fleming's rule. Therefore, a closed magnetic circuit is formed through the magnets 55a and 55b, so that magnetic force is applied to the slide table 53 and moves it toward the left side.

On the other hand, when current flows from the second fixed electrode 52 to the first fixed electrode 51 due to the alternating voltage 57, magnetic flux in the direction from paper face toward paper back of FIG. 5A (that is, in direction from magnet 55a to magnet 55b in FIG. 5B) is generated. Thus, magnetic force is applied to the slide table 53 and moves it toward the right side.

As described above, the slide table 53 tends to return the center position thereof due to the elastic force of the plate springs 51a. Accordingly, the slide table 53 can be reciprocated (vibrated) in the left-right direction due to the alternating voltage 57 supplied between the first fixed electrode 51 and the second fixed electrode 52. Thus, the cylinder lens 33 mounted at the slide table 53 can slide in the direction perpendicular to the laser route LR of the laser beam LB. The sliding speed of the slide table 53 can be controlled, by adjusting the frequency (switching frequency) of the alternating voltage 57.

According to this embodiment, the optical scanner 30 of the laser radar 20 includes the laser diode 32 for emitting laser beam LB, the cylinder lens 33 arranged in the laser route LR of the laser beam LB, and the static electricity force driving device 40 (or the electromagnetic force driving device 50), which moves the cylinder lens 33 in the direction perpendicular to the laser route LR to change the incidence position of the laser beam LB with respect to the cylinder lens 33. That is, in the optical scanner 30, the cylinder lens 33 is arranged in the laser route LR, and driven by the static electricity force driving device 40 (or electromagnetic force driving device 50) to move in the direction perpendicular to the laser route LR.

Accordingly, the laser beam LB having entered the cylinder lens 33 can be refracted at different refraction angles to be dispersed, thus being capable of scanning the object. Therefore, the optical scanner 30 according to this embodiment can be small sized at least in the direction of the laser route LR, as compared with that having a revolving polygon mirror. Thus, a driving motor for rotating the polygon mirror, which is big and heavy, is unnecessary, thus reducing the size and weight of the optical scanner 30. Moreover, the component cost of the optical scanner 30 is decreased.

Thus, the small-sized and lightweight laser radar 20 can be mounted with less restriction. The laser radar 20 can be mounted at positions having a good visibility at the front portion of the vehicle, for example, at the backside of a back mirror or the front side of an instrument panel in the passenger compartment. Furthermore, because the static electricity force driving device 40 (or the electromagnetic force driving device 50) is used as the driving unit, the electrical power cost of the optical scanner 30 can be decreased.

### Second Embodiment

In the above-described first embodiment, the cylinder lens 33 is slidable while the laser diode 32 is fixed. According to a second embodiment of the present invention, the cylinder lens 33 is fixed while the laser diode 32 is slidable.

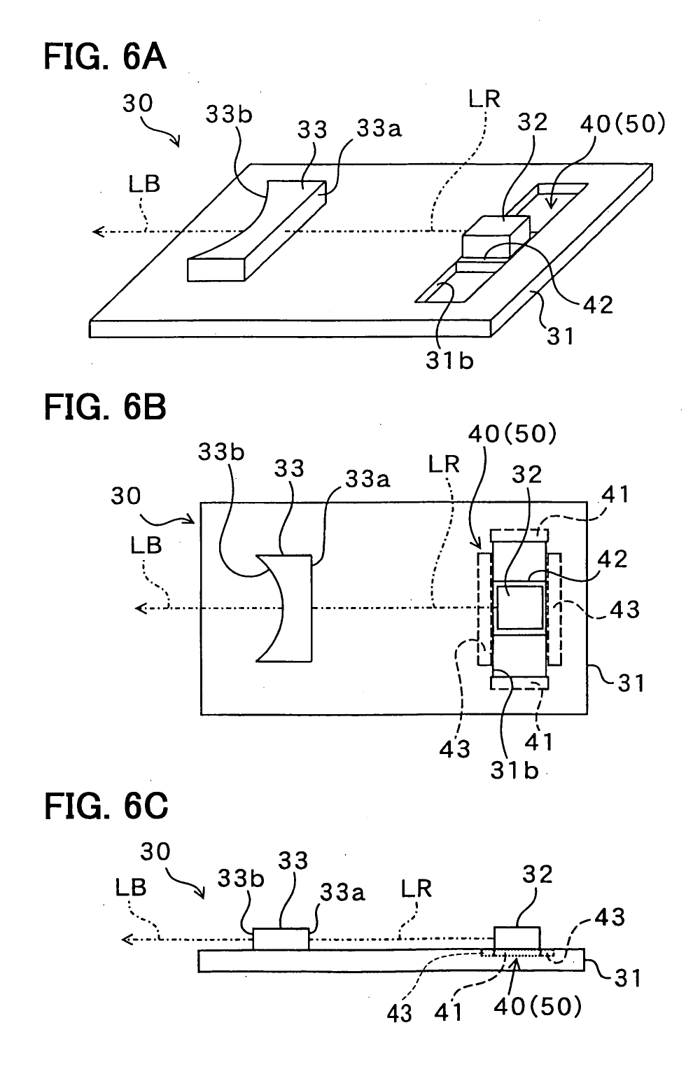

Referring to FIGS. 6A-6C, the cylinder lens 33 is fixed at the board 31 and disposed in the laser route LR of the laser beam LB emitted by the laser diode 32.

The board 31 is provided with a guide groove 31b corresponding to the position of the laser diode 32. The laser diode 32 is mounted at the slide table 42 (or slide table 53) driven by the driving unit (e.g., static electricity force driving device 40 or electromagnetic force driving device 50), thus being capable of sliding in the direction perpendicular to the laser route LR. The slide table 42 (or slide table 53) is slidable along the guide groove 31b in the direction perpendicular to the laser route LR. Therefore, the relative position of the cylinder lens 33 to the light route LR of the laser beam LB emitted by the laser diode 32 is changeable.

Thus, the laser beam LB having entered the cylinder lens 33 is refracted at different refraction angles to be dispersed, thus being capable of scanning the object. Therefore, similar to the first embodiment, the laser radar 20 provided with the optical scanner 30 can be small-sized and weight-reduced. Thus, the laser radar 20 can be mounted with less restriction. Furthermore, the power cost and the component cost of the laser radar 20 can be reduced.

In this embodiment, the construction of the laser radar 20 (including optical scanner 30) which has not been described is the same with the first embodiment.

### Third Embodiment

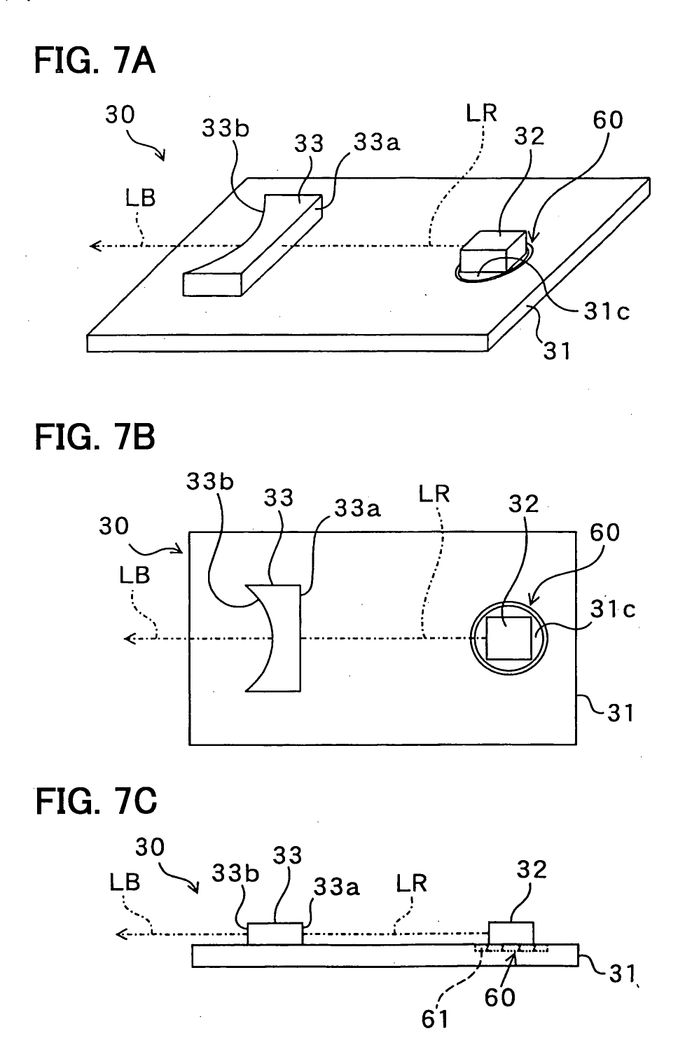

In the above-described embodiments, one of the cylinder lens 33 and the laser diode 32 is slideable with respect to the other. According to a third embodiment referring to FIGS. 7A-7C, the laser diode 32 is rotatable with respect to the cylinder lens 33.

In this case, the cylinder lens 33 is fixed on the board 31. The laser diode 32 is mounted at a turn table 31c rotated by a rotation driving device 60, which is the driving unit in this embodiment. The rotation driving device 60 can be, for example, a static electricity motor of an induction type (variable capacity motor) which is a micromachine using static electricity force as driving force, similar to the static electricity force driving device 40.

The turn table 31c, being rotatably mounted on the board 31, can be rotated clockwise or anti-clockwise by the rotation driving device 60, which has an electrode 61 formed at the board 31 with reference to FIG. 7C. The laser diode 32 is mounted on the turn table 31c to rotate along with it. Thus, the laser route LR of the laser beam LB emitted by the laser diode 32 is rotatable. Therefore, the incidence position of the laser beam LB with respect to the cylinder lens 33 is changeable. That is, the relative position of the cylinder lens 33 to the laser route LR is changeable. Accordingly, the laser beam LB having entered the cylinder lens 33 can be refracted (dispersed) at different refraction angles in a fan shape, thus being capable of scanning the object.

According to this embodiment, because the laser diode 32 is rotated on the surface (plane) of the board 31, the optical scanner 30 can be small sized, as compared with that where the polygon mirror or the like is used. Therefore, a driving motor for rotating the polygon mirror is unnecessary, thus reducing the size and weight of the optical scanner 30. Moreover, the component cost of the optical scanner 30 is decreased. The small-sized and lightweight laser radar 20 can be mounted with less restriction. Moreover, the rotation driving device 60 is used as the driving unit, so that the electric power cost of the laser radar 20 can be reduced.

On the other hand, the laser diode 32 can be also fixed on the board 31, while the cylinder lens 33 is mounted at the turn table 31c to rotate along with it. Thus, the relative position of the cylinder lens 33 to the laser route LR is changeable, which has a same effect with the case where the laser diode 32 is rotated.

In this embodiment, the construction of the laser radar 20 (including optical scanner 30) which has not been described is the same with the first embodiment.

### Fourth Embodiment

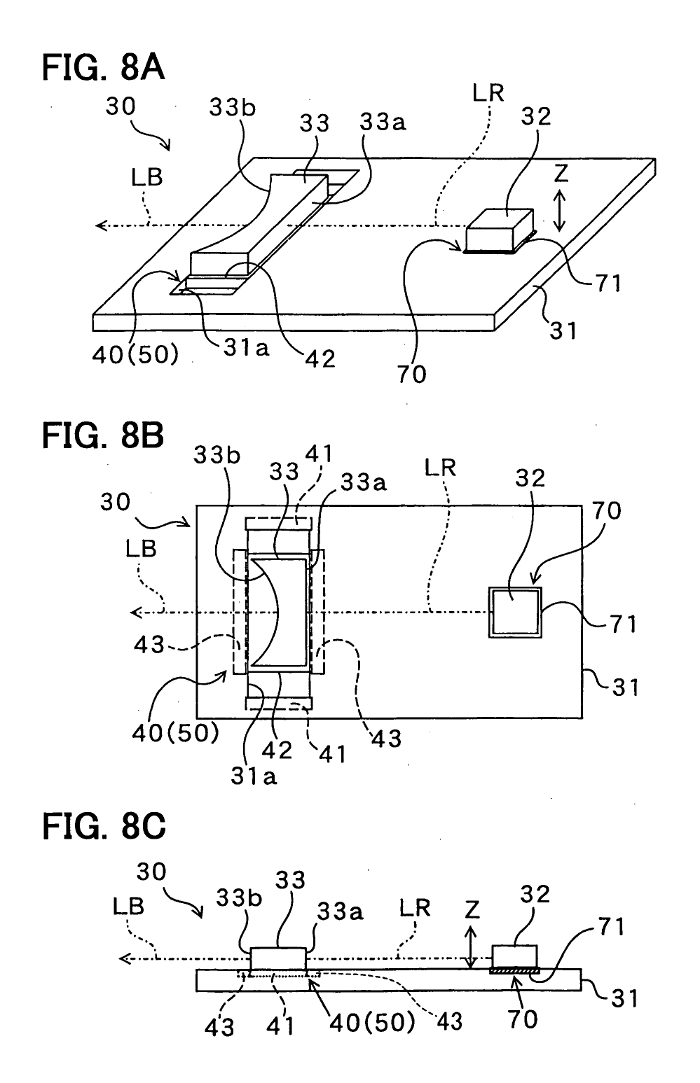

According to a fourth embodiment with reference to FIG. 8A-8C, the laser diode 32 is movable in the thickness direction (lateral direction) of the cylinder lens 33, and the cylinder lens 33 is slidable in the longitudinal direction thereof.

In this case, the driving unit of the optical scanner 30 includes the static-electricity-force driving device 40 (or electromagnetic force driving device 50) for driving the cylinder lens 33 and an ascent/descent driving device 70 for driving the laser diode 32.

Specifically, the cylinder lens 33 is mounted on the slide table 42 (or slide table 53) of the static-electricity-force driving device 40 (or electromagnetic force driving device 50), thus being slidable in the direction perpendicular to the laser ray LR of the laser beam LB.

The ascent/descent driving device 70 has a piezoelectric portion 71 (e.g., PZT), at which the laser diode 32 is mounted. When voltage is supplied for the piezoelectric portion 71, the piezoelectric portion 7 will deform so that the thickness thereof is changed. Thus, the laser diode 32 is movable in the thickness direction (i.e., Z direction indicated in FIGS. 8A and 8C) of the piezoelectric portion 71 (cylinder lens 33).

Accordingly, besides the sliding of the cylinder lens 33 driven by the static electricity force driving device 40 (or electromagnetic force driving device 50) in the direction perpendicular to the laser route LR (i.e., longitudinal direction of cylinder lens 33), the laser diode 32 can be moved in the thickness direction of the cylinder lens 33 by the ascent/descent driving device 70. Thus, the laser beam LB can scan the object in both the longitudinal direction and the lateral direction of the cylinder lens 33. That is, a two-dimension scanning of the object is capable.

Therefore, according to this embodiment, the laser radar 20 provided with the optical scanner 30 can be small-sized and weight-reduced, thus being mounted with less restriction. Furthermore, the two-dimension scanning of the object can be realized.

In this embodiment, the construction of the laser radar 20 (including optical scanner 30) which has not been described is the same with the first embodiment.

### Fifth Embodiment

According to a fifth embodiment, the cylinder lens 33 can be moved in both the thickness direction and the longitudinal direction thereof by the driving unit including the static-electricity-force driving device 40 (or electromagnetic force driving device 50) and the ascent/descent driving device 70.

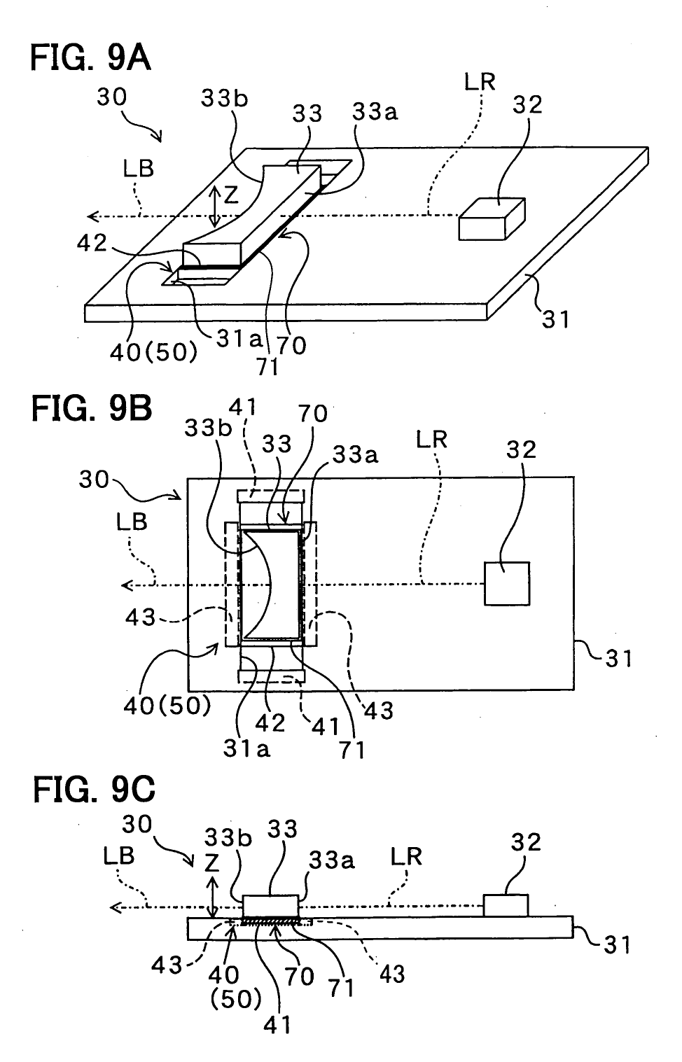

As shown in FIGS. 9A-9C, the piezoelectric portion 71 of the ascent/descent driving device 70 (described in above-described fourth embodiment) is mounted at the slide table 42 (or 53) driven by the static electricity force driving device 40 (or electromagnetic force driving device 50). The cylinder lens 33 is fixed at the piezoelectric portion 71 of the ascent/descent driving device 70. Thus, the cylinder lens 33 can be moved in the thickness direction thereof (z direction indicated in FIGS. 9A and 9C) by the ascent/descent driving device 70, while the piezoelectric portion 71 is slidable in the longitudinal direction of the cylinder lens 33 along with the slide table 42 (or 53) driven by the static electricity force driving device 40 (or electromagnetic force driving device 50). Therefore, the cylinder lens 33 is movable in both the thickness direction and the longitudinal direction thereof.

Accordingly, the laser beam LB can scan the object in both the longitudinal direction and the thickness direction of the cylinder lens 33. That is, the two-dimension scanning of the object is capable according to the fifth embodiment.

Similarly, the laser radar 20 provided with the optical scanner 30 can be small-sized and weight-reduced, thus being mounted with less restriction.

In this embodiment, the construction of the laser radar 20 (including optical scanner 30) which has not been described is the same with the first embodiment.

### Sixth Embodiment

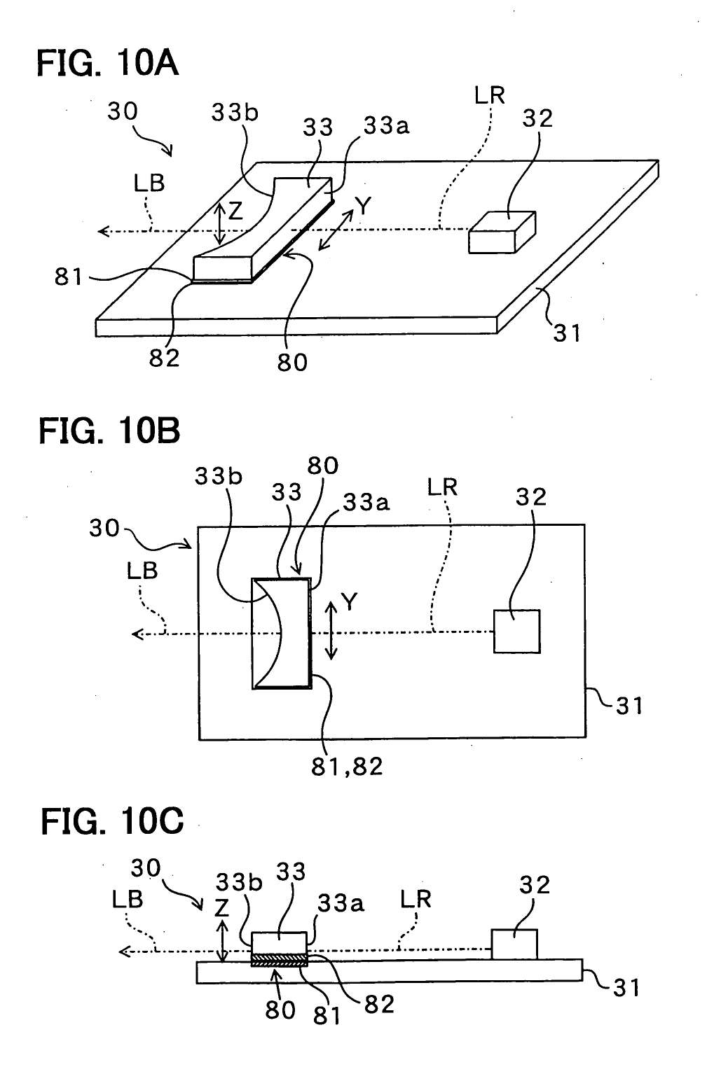

In the above-described embodiments, the static electricity force driving device 40 (or electromagnetic force driving device 50) is used to move the cylinder lens 33 or the laser diode 32 in the longitudinal direction of the cylinder lens 33. The ascent/descent driving device 70 is used to move the cylinder lens 33 or the laser diode 32 in the thickness direction of the cylinder lens 33. According to a sixth embodiment, a Y/Z direction driving device 80 (two-direction driving device) is used as the driving unit for moving the cylinder lens 33 in both the longitudinal direction (length direction) and the thickness direction thereof. The longitudinal direction and the thickness direction of the cylinder lens 33 are respectively indicated as the Y direction in FIGS. 10A, 10B and the Z direction in FIGS. 10A, 10C.

Referring to FIGS. 10A-10C, the laser diode 32 is fixed at the board 31. The cylinder lens 33 is mounted on the Y/Z direction driving device 80. The Y/Z direction driving device 80 can be, for example, a two-tier type which includes piezoelectric portions 81 and 82 adhering to and overlapping each other. When voltage is supplied for the piezoelectric portion 81, the piezoelectric portion 81 will deform so that the length (Y direction dimension) thereof is changed. When voltage is supplied for the piezoelectric portion 82, the piezoelectric portion 82 will deform so that the thickness (Z direction dimension) thereof is changed. That is, the piezoelectric portions 81 and 82 respectively deform in the length direction (longitudinal direction) and the thickness direction thereof.

Thus, the cylinder lens 33 is movable in both the Y and X directions. Therefore, the relative position of the cylinder lens 33 to the laser route LR can be changed without using the static electricity force driving device 40, the electromagnetic force driving device 50, the rotation deriving device 60 and the ascent/descent driving device 70 by MEMS.

According to this embodiment, the cylinder lens 33 is movable in both the thickness direction of the cylinder lens 33 by the piezoelectric portion 82, and the longitudinal direction of the cylinder lens 33 by the piezoelectric portion 81. Thus, the laser beam LB having entered the cylinder lens 33 is refracted and dispersed in a fan shape, thus being capable of scanning the object. The laser beam LB can scan the object in both the longitudinal direction and the thickness direction of the cylinder lens 33. That is, the two-dimension scanning of the object is capable.

Accordingly, the laser radar 20 provided with the optical scanner 30 can be small-sized and weight-reduced. The electric power cost of the laser radar 20 can be decreased.

On the other hand, the Y/Z direction driving device 80 can be also used as the driving unit for moving the laser diode 32 in both the longitudinal direction (length direction) and the thickness direction of the cylinder lens 33, while the cylinder lens 33 is fixed at the board 31.

In this embodiment, the construction of the laser radar 20 (including optical scanner 30) which has not been described is the same with the first embodiment.

### Seventh Embodiment

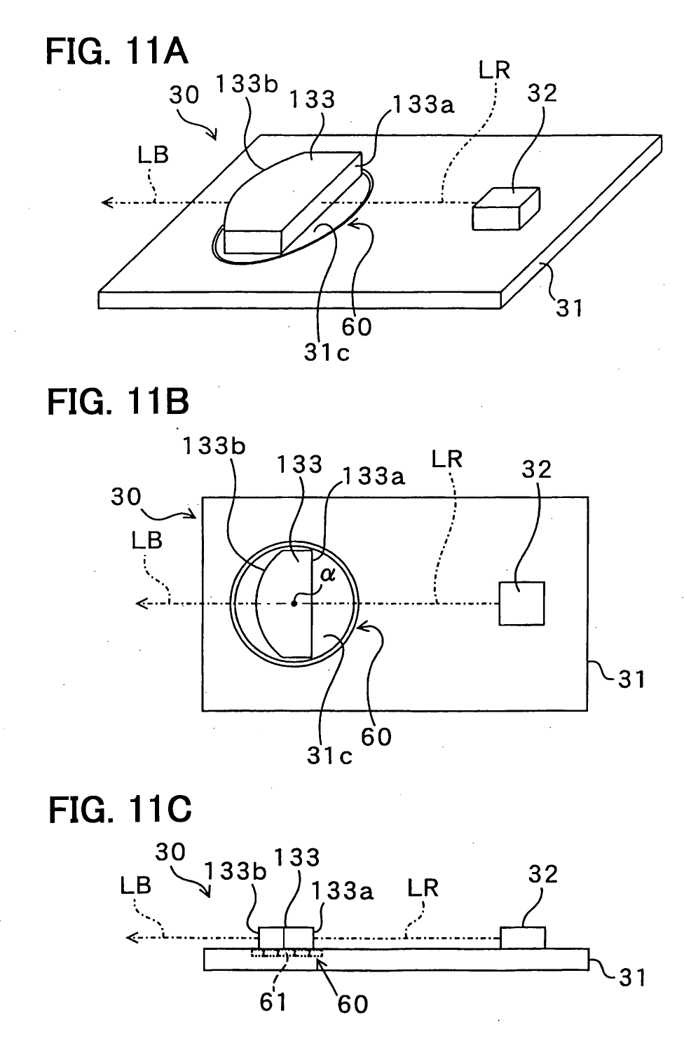

In the above-described embodiments, the dispersion lens is used as the cylinder lens 33. According to a seventh embodiment with reference to FIGS. 11A-11C, a convergence lens (cylinder lens 133) is used instead of the dispersion lens (cylinder lens 33). In this case, the cylinder lens 133 is constructed of the convergence lens such as a positive lens (convex lens) converging parallel light.

In this embodiment, the cylinder lens 133, being made of quartz glass, plastic or the like, is a columnar plano-convex lens having an incidence lens surface 133a (being plane) at an incidence side of the laser beam LB and an outgoing lens surface 133b (being convex) at an outgoing side of the laser beam LB. The incidence lens surface 133a and the outgoing lens surface 133b are separately disposed at two opposite sides of the cylinder lens 133. The outgoing lens surface 133b is curved in the longitudinal direction (length direction) of the cylinder lens 133, but not curved in the thickness direction thereof. That is, the outgoing lens surface 133b has a substantially zero curvature in the thickness direction of the cylinder lens 133.

Referring to FIGS. 11A-11C, the optical scanner 30 includes the board 31, the laser diode 32 for emitting laser beam LB, the cylinder lens 133 arranged in the laser route LR of the laser beam LB, and the rotation driving device 60 (driving unit) which is the same with that described in the above-described third embodiment. The laser diode 32 is fixed at the board 31. The cylinder lens 133 is fixed on the turn table 31c, which is rotatably mounted on the board 31. The turn table 31c is driven by the rotation driving device 60, thus being capable of rotating clockwise or anti-clockwise with a center of an arbitrary point a at the laser route LR.

Therefore, the cylinder lens 133 arranged in the laser route LR can be rotated with the center of the arbitrary point a at the laser route LR.

The cylinder lens 133 refracts (converges) the laser beam LB to the focal point (disposed at the lens axis) of the cylinder lens 133, notwithstanding the incidence position of the laser beam LB. In this case, the cylinder lens 133 can be rotated by the rotation driving device 60 with the center of the arbitrary point a at the laser route LR, so that the convergence direction of the laser beam LB entering the cylinder lens 133 is changeable. Therefore, the optical scanner 30 can scan the object.

Thus, according to this embodiment, the laser radar 20 provided with the optical scanner 30 can be small-sized and weight-reduced, as compared with that where the polygon mirror or the like is used. Therefore, the driving motor for rotating polygon mirror is unnecessary, thus reducing the component cost.

Accordingly, the laser radar 20 can be mounted at positions having a good visibility at the front portion of the vehicle, for example, at the backside of a back mirror or the front side of an instrument panel in the passenger compartment. In this embodiment, the construction of the laser radar 20 (including optical scanner 30) which has not been described is the same with the first embodiment.

### Other Embodiment

Although the present invention has been fully described in connection with the preferred embodiments thereof with reference to the accompanying drawings, it is to be noted that various changes and modifications will become apparent to those skilled in the art.

In the above-described embodiments, the optical scanner 30 is suitably used in the laser radar 20. However, the optical scanner 30 can be also used in other systems to detect (scan) an object.

Such changes and modifications are to be understood as being in the scope of the present invention as defined by the appended claims.

1. An optical scanner comprising:
a light source for emitting a light beam;
a dispersion lens arranged in a light route of the light beam; and
a driving unit which moves at least one of the light source and the dispersion lens in at least a direction perpendicular to the light route so that an incidence position of the light beam with respect to the dispersion lens is changeable.

2. The optical scanner according to claim 1, wherein
the dispersion lens is a columnar plano-concave lens which has an incidence lens surface at an incidence side of the light beam and an outgoing lens surface at an outgoing side of the light beam, the incidence lens surface and the outgoing lens surface being respectively disposed at two opposite sides of the dispersion lens, the outgoing lens surface being curved in a longitudinal direction of the dispersion lens.

3. The optical scanner according to claim 2, wherein:
the outgoing lens surface has a substantially zero curvature in a thickness direction of the dispersion lens; and
at least one of the light source and the dispersion lens is movable in the thickness direction of the dispersion lens.

4. An optical scanner comprising:
a light source for emitting a light beam;
a convergence lens arranged in a light route of the light beam; and
a driving unit which rotates the convergence lens with a center of an arbitrary point at the light route so that a convergence direction of the light beam entering the convergence lens is changeable.

5. The optical scanner according to claim 4, wherein
the convergence lens is a columnar plano-convex lens having an incidence lens surface at an incidence side of the light beam and an outgoing lens surface at an outgoing side of the light beam, the incidence lens surface and the outgoing lens surface being respectively disposed at two opposite sides of the convergence lens, the outgoing lens surface being curved in a longitudinal direction of the convergence lens.

6. The optical scanner according to claim 5, wherein:
the outgoing lens surface has a substantially zero curvature in a thickness direction of the convergence lens; and
at least one of the light source and the convergence lens is movable in the thickness direction of the convergence lens.

7. The optical scanner according to claim 1, wherein the driving unit includes at least one of a static electricity force driving device using static electricity force as driving force, an electromagnetic force driving device using electromagnetic force as driving force, and an ascent/descent driving device having a piezoelectric portion, which deforms when voltage is supplied for the piezoelectric portion.

8. The optical scanner according to claim 1, wherein the driving unit is a two-direction driving device for moving one of the dispersion lens and the light source in both a longitudinal direction and a thickness direction of the dispersion lens.

9. The optical scanner according to claim 8, wherein the two-direction driving device has piezoelectric portions, which respectively deform in a longitudinal direction and a thickness direction thereof when voltage is supplied for the piezoelectric portions.

10. An optical scanner comprising:
a light source for emitting a light beam;
a dispersion lens arranged in a light route of the light beam; and
a driving unit which rotates one of the light source and the dispersion lens on a plane so that a relative position of the dispersion lens to the laser route is changeable.

11. The optical scanner according to claim 4, wherein the driving unit is a static electricity motor of an induction type.

12. The optical scanner according to claim 10, wherein the driving unit is a static electricity motor of an induction type.

13. The optical scanner according to claim 1, wherein the light source is a laser diode.
